(19) United States
(12) Patent Application Publication
(10) Pub. No.: US 2012/0275840 A1
(43) Pub. Date: Nov. 1, 2012

(54) MULTI-COLORED PENCIL

(76) Inventor: Bihua LIU, Bayside, NY (US)

(21) Appl. No.: 13/181,192

(22) Filed: Jul. 12, 2011

(30) Foreign Application Priority Data
Apr. 26, 2011 (CN) 201120125765.X

(51) Int. Cl. B43K 27/04

(52) U.S. Cl. 401/35

(57) ABSTRACT

The present invention provides a multi-colored pencil comprising a pencil lead embedded in a body made from toner powders of one or more colors, wherein the body is typically cylindrical in shape and made by compressing said toner powders against the lead. The pencil body preferably consists of two or more colors so that the colors are vertically separated. The pencil of the present invention, once sharpened, can be used to write and draw lines like any other pencil, but can also be used to draw colorful pictures using the different colors on the pencil body and the pencil lead. When new, the pencil can draw in different colors even without sharpening.

### CROSS-REFERENCES TO RELATED APPLICATIONS

This application claims priority of Chinese Application No. CN 201120125765.X, filed Apr. 26, 2011, which is hereby incorporated in its entirety by reference into this application.

### BACKGROUND OF THE INVENTION

Currently, pencils available on the market are composed of a piece of lead wrapped around in a hardened material, typically wood, forming the body. The wood is shaved off to expose the sharpened lead part as the pencil is continually used, resulting in significant waste of wood, a process not environmentally sound. The lead is typically black, although it can be of a different color, but only one color. Therefore, to write or draw in more than one color, multiple pencils of different colors are needed and have to be used in turns, not a very convenient process compared to using one pencil having multiple colors. Although there are ballpoint pens that can write or draw in several colors, the effects are distinctly different from those of a pencil. CN 01253949.X discloses a multi-colored pencil which does not contain a pencil lead in the middle. The present invention provides a pencil that can be used to write like a regular pencil and draw in multiple colors.

### SUMMARY OF THE INVENTION

The present invention provides a multi-colored pencil comprising a pencil lead embedded in a body made from toner powders of one or more colors, wherein the body is typically cylindrical in shape and made by compressing said toner powders against the lead. The pencil lead is typically black, but can be a different color. The pencil body preferably consists of two or more colors so that the colors are vertically separated. The pencil body can also be one color, different from that of the pencil lead. The pencil of the present invention, once sharpened, can be used to write and draw lines like any other pencil, but can also be used to draw colorful pictures using the different colors in the pencil body and the lead. When new, the pencil can draw in different colors even without sharpening.

### BRIEF DESCRIPTION OF THE DRAWINGS

FIG. 1 depicts a cross-sectional view of a pencil of the present invention having a lead (1) in the middle and a body (2) with two different colors.

FIG. 2 depicts a cross-sectional view of a pencil of the present invention having a lead (1) in the middle and a body (2) with three different colors.

FIG. 3 depicts a cross-sectional view of a pencil of the present invention having a lead (1) in the middle and a body (2) with four different colors.

### DETAILED DESCRIPTION OF THE INVENTION

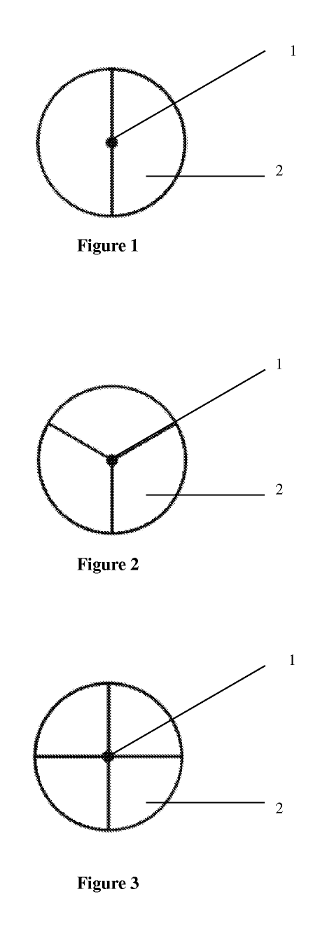

The present invention provides a multi-colored pencil having a lead in the middle embedded in a body made by compressing toner powders of one or more colors against the lead wherein each color on the body is separate from the other colors. The colors are preferentially distributed vertically as shown in FIGS. 1, 2 and 3. The colors can be any colors, such as red, orange, yellow, green, cyan-blue, blue, purple, white and black, just to name a few. The pencil lead is typically black, but can be a different color.

FIG. 1 shows an example of the present invention which has a piece of lead in the middle, black or another color, embedded in a body made from toner powders of two different colors such that half of the body is of one color and the other half the other color. FIG. 2 shows an example of a pencil which has a piece of lead in the middle, black or another color, embedded in a body made from toner powders of three different colors such that each one-third of the body is of a different color. Similarly, FIG. 3 shows an example of a pencil having a body with four different colors.

The multi-colored pencil of the present invention can be sharpened with a pencil sharpener like any other pencil. The pencil is typically cylindrical in shape so that the cross-section of the pencil is round. The pencil may optionally have an eraser at one end. The diameter of the pencil can also be varied.

After a pencil of the present invention is sharpened, it can write and draw lines like a regular pencil because it has a lead in the middle. Moreover, it can draw in color if held and moved at an angle so that the shaved part of the body is in contact with a drawing medium such as a piece of paper. Changing the color can be easily achieved by rotating the pencil around its longer axis such that a different color of the body is in contact with the drawing medium. Indeed, it can draw in two different colors at the same time if it is held and moved such that the intersection of two colors on the body is in contact with the drawing medium. In this manner, one can finish a drawing with different colors by using only one pencil.

The present invention provides a pencil comprising a pencil lead embedded in a body made of toner powders of one or more colors. In one embodiment, the pencil is cylindrical in shape. In another embodiment, the pencil body is made by compressing said toner powders against the pencil lead. In a further embodiment, the colors on said pencil body are separated vertically.

In one embodiment, the multi-colored pencil of the present invention further comprises an eraser. In another embodiment, the colors of the pencil are selected from red, orange, yellow, green, cyan-blue, blue, purple, white, black and variations thereof. In yet another embodiment, the pencil body is made of toner powders of two, three or four colors. In a further embodiment, the pencil lead is black.

The present invention also provides a method of using a multi-colored pencil for writing and drawing, comprising the steps of:

1. Optionally sharpening one end of the pencil with a pencil sharpener;

2. Contacting at least one color of the pencil body with a drawing medium to draw;

3. Optionally rotating the pencil along its longer axis to draw in a different color; and

4. Optionally writing or drawing lines with the pencil lead;

wherein said pencil comprises a pencil lead embedded in a body made of toner powders of one or more colors.

In one embodiment of the method, the pencil is cylindrical in shape. In another embodiment, the colors on the pencil body are separated vertically. In yet another embodiment of the method, contacting in step 2 is contacting the sharpened portion of the pencil body with a drawing medium. In a further embodiment, the drawing medium is a piece of paper. In one embodiment of the method, the colors are selected from red, orange, yellow, green, cyan-blue, blue, purple, white, black and variations thereof. In another embodiment, the pencil body is made of toner powders of two, three or four colors. In still another embodiment, the pencil lead is black.

The invention will be better understood by reference to the Experimental Details which follow, but those skilled in the art will readily appreciate that the specific experiments detailed are only illustrative, and are not meant to limit the invention as described herein, which is defined by the claims which follow thereafter.

Throughout this application, various references or publications are cited. Disclosures of these references or publications in their entireties are hereby incorporated by reference into this application in order to more fully describe the state of the art to which this invention pertains. It is to be noted that the transitional term “comprising”, which is synonymous with “including”, “containing” or “characterized by”, is inclusive or open-ended and does not exclude additional, un-recited elements or method steps.

### EXAMPLE 1

### Manufacture of a Pencil with Three Colors

Place a pencil lead (1) between toner powders of two different colors, and then compress the powders from opposite directions so that the powders adhere to the lead and form the shape of a pencil.

### EXAMPLE 2

### Manufacture of a Pencil with Four Colors

Place a pencil lead (1) among toner powders of three different colors, and then compress the powders from three directions at 120° of one another so that the powders adhere to the lead and form the shape of a pencil.

### EXAMPLE 3

### Manufacture of a Pencil with Five Colors

Place a pencil lead (1) among toner powders of four different colors, and then compress the powders from four directions at 90° of one another so that the powders adhere to the lead and form the shape of a pencil.

1. A multi-colored pencil, comprising a pencil lead embedded in a body made of toner powders of one or more colors.

2. The pencil of claim 1, wherein the pencil is cylindrical in shape.

3. The pencil of claim 1, wherein the pencil body is made by compressing said toner powders against the pencil lead.

4. The pencil of claim 1, wherein the colors on said pencil body are separated vertically.

5. (canceled)

6. The pencil of claim 1, wherein the colors are selected from red, orange, yellow, green, cyan-blue, blue, purple, white, black and variations thereof.

7. The pencil of claim 1, wherein the pencil body is made of toner powders of two, three or four colors.

8. The pencil of claim 1, wherein the lead is black.

9-17. (canceled)
